(19) United States
(12) Patent Application Publication
(10) Pub. No.: US 2026/0286235 A1
(43) Pub. Date: Sep. 24, 2026

(54) HEAVY OIL HYDROREFINING METHOD

(71) Applicant: ENEOS Corporation, Tokyo (JP)

(72) Inventors: Chikanori NAKAOKA, Tokyo (JP); Masaya KANI, Tokyo (JP); Koichi MATSUSHITA, Tokyo (JP); Ryo KISHIDA, Tokyo (JP)

(73) Assignee: ENEOS Corporation, Tokyo (JP)

(21) Appl. No.: 19/478,501

(22) PCT Filed: Mar. 1, 2024
(86) PCT No.: PCT/JP2024/007816

§ 371 Date: Oct. 24, 2025

(30) Foreign Application Priority Data
May 1, 2023 (JP) 2023-075682

(51) Int. Cl. C10G 45/08; B01J 27/19; B01J 35/61; B01J 35/63; B01J 35/64

(52) U.S. Cl. CPC C10G 45/08; B01J 27/19; B01J 35/615; B01J 35/633; B01J 35/647; B01J 35/651; C10G 2300/1044; C10G 2300/202; C10G 2300/70

(57) ABSTRACT

A heavy oil hydroprocessing method includes a step of sequentially bringing a heavy oil into contact with a first hydrogenation catalyst, a second hydrogenation catalyst, and a third hydrogenation catalyst, which are placed in a downflow-type fixed bed reaction apparatus, in the presence of hydrogen. Both the first hydrogenation catalyst and the second hydrogenation catalyst include macropores and mesopores. The pore distribution of the first hydrogenation catalyst has a peak at a pore diameter of 50 nm or more and a peak at a pore diameter of less than 50 nm. The pore distribution of the second hydrogenation catalyst also has a peak at a pore diameter of 50 nm or more and a peak at a pore diameter of less than 50 nm. The volume V1_{MACRO} of the macropores in the first hydrogenation catalyst is larger than the volume V2_{MACRO} of the macropores in the second hydrogenation catalyst.

### TECHNICAL FIELD

The present disclosure relates to a heavy oil hydroprocessing method.

### BACKGROUND ART

In order to reduce impurities (sulfur components, metal components, and asphaltene components) in a heavy oil, such as petroleum residue oil (for example, vacuum residue), hydroprocessing of a heavy oil has been performed. In hydroprocessing, a heavy oil is brought into contact with a hydrogenation catalyst at high temperature and high pressure in the presence of hydrogen. Since a heavy oil contains large amounts of metal components and asphaltene components, metal components and coke components are deposited on the surface of the hydrogenation catalyst as the hydroprocessing is continued. As a result, the activity of the hydrogenation catalyst gradually decreases, and finally, it becomes difficult to continue the operation due to restrictions on the reaction apparatus and produced oil properties, and the life of the hydrogenation catalyst is exhausted. Therefore, in the hydroprocessing of a heavy oil, it is desired to further improve the activity (performance of removing impurities) of the hydrogenation catalyst and further extend the life of the hydrogenation catalyst. For this reason, a method of improving the performance of the hydrogenation catalyst itself and combining a plurality of hydrogenation catalysts, that play different roles in accordance with the reactivity of each impurity in a heavy oil, is adopted. In particular, in order to protect a hydrodesulfurization catalyst serving as a main catalyst, it is important to remove metal components and asphaltene components in a heavy oil by a demetallization catalyst disposed in the front of the hydrodesulfurization catalyst.

As a hydroprocessing method using a plurality of catalysts, Patent Literature 1 below discloses a method in which a heavy oil is sequentially brought into contact with a former catalyst, a middle catalyst, and a latter catalyst in the presence of hydrogen. In the hydroprocessing method described in Patent Literature 1 below, the volume ratio of each of the former catalyst, the middle catalyst, and the latter catalyst that are different in pore diameter is adjusted within a specific numerical range. Then, a metal compound which is easy to react among the metal components is removed by the former catalyst, a metal compound which is difficult to react among the metal components is removed by the middle catalyst, and mainly sulfur components are removed by the latter catalyst. Patent Literature 2 below also discloses a heavy oil hydroprocessing method using a former catalyst, a middle catalyst, and a latter catalyst. In the hydroprocessing method described in Patent Literature 2 below, the desulfurization activity of the latter catalyst is characterized particularly by the addition of silicon and phosphorus to the latter catalyst.

Patent Literatures 3 and 4 below disclose a hydrogenation catalyst including not only mesopores but also macropores that promote diffusion of macromolecules as a catalyst for reducing metal components and asphaltene components.

### CITATION LIST

### Patent Literature

Patent Literature 1: Japanese Unexamined Patent Publication No. 2003-171671
Patent Literature 2: Japanese Patent No. 6773384
Patent Literature 3: Japanese Patent No. 4538014
Patent Literature 4: Japanese Patent No. 4818163

### SUMMARY OF INVENTION

### Technical Problem

However, the conventional hydrogenation catalyst described above does not have sufficient performance because it is not designed with a focus on the reactivity of the metal compound or the asphaltene components which are difficult to react. For example, in the design of the conventional hydrogenation catalyst, the molecular size and reactivity of each of the metal components and the asphaltene components are not taken into account, and thus the conventional hydrogenation catalyst does not have an optimal pore structure, that is, an existence state (pore distribution) of a pore diameter and a pore volume. Therefore, in the conventional hydroprocessing, it is difficult to sufficiently remove impurities (such as metal components and asphaltene components) that reduce the activity of the hydrodesulfurization catalyst from a heavy oil and to achieve a long life of the hydrogenation catalyst. For example, by increasing the reaction temperature of the hydroprocessing, the activity of the hydrogenation catalyst for removing impurities is improved. However, the operation of increasing the reaction temperature promotes the deposition of coke components and the like, and rapidly decreases the activity of the hydrogenation catalyst. Therefore, it is difficult to stably operate a hydroprocessing apparatus using the conventional hydrogenation catalyst at a high reaction temperature for a long time. Further, although each of the former catalyst (demetallization catalyst), the middle catalyst, and the latter catalyst (hydrodesulfurization catalyst) is improved, and the performance of the individual catalyst is improved, the performance of each catalyst may not be sufficiently exhibited when a plurality of catalysts are combined. In addition, since the demand for light fractions (such as kerosene and a light oil) is larger than the demand for a heavy oil, it is desired to produce more light fractions from a heavy oil by a cracking reaction that occurs simultaneously at the time of hydroprocessing of the heavy oil and a reaction in a fluid catalytic cracking apparatus disposed at the rear of a hydroprocessing apparatus.

An object of one aspect of the present invention is to provide a heavy oil hydroprocessing method, in which a hydrogenation catalyst has an excellent activity of removing impurities from a heavy oil and the activity of the hydrogenation catalyst is maintained for a long time.

### Solution to Problem

One aspect of the present invention relates to a heavy oil hydroprocessing method according to any one of the following [1] to [10].
[1]A heavy oil hydroprocessing method, including a step of sequentially bringing a heavy oil into contact with a first hydrogenation catalyst, a second hydrogenation catalyst, and a third hydrogenation catalyst in the presence of hydrogen, in which
the first hydrogenation catalyst, the second hydrogenation catalyst, and the third hydrogenation catalyst are placed in a downflow-type fixed bed reaction apparatus,
the first hydrogenation catalyst, the second hydrogenation catalyst, and the third hydrogenation catalyst are different catalysts,
both the first hydrogenation catalyst and the second hydrogenation catalyst include macropores and mesopores,
a pore diameter of the macropores is 50 nm or more,
a pore diameter of the mesopores is less than 50 nm,
a pore distribution (a distribution where a pore volume is plotted against a logarithm of a pore diameter) of the first hydrogenation catalyst has a peak where a pore volume at a pore diameter of 50 nm or more reaches a local maximum and a peak where a pore volume at a pore diameter of less than 50 nm reaches a local maximum,
a pore distribution (a distribution where a pore volume is plotted against a logarithm of a pore diameter) of the second hydrogenation catalyst has a peak where a pore volume at a pore diameter of 50 nm or more reaches a local maximum and a peak where a pore volume at a pore diameter of less than 50 nm reaches a local maximum,
a volume V1_{MACRO} of the macropores in the first hydrogenation catalyst is larger than a volume V2_{MACRO} of the macropores in the second hydrogenation catalyst,
a specific surface area of the first hydrogenation catalyst is 185 m²/g or more,
a specific surface area of the second hydrogenation catalyst is 160 m²/g or more, and
a content of a Group 6 element in the second hydrogenation catalyst is 5 mass % or more and 7 mass % or less.
[2]A heavy oil hydroprocessing method, including a step of sequentially bringing a heavy oil into contact with a first hydrogenation catalyst, a second hydrogenation catalyst, and a third hydrogenation catalyst in the presence of hydrogen, in which
the first hydrogenation catalyst, the second hydrogenation catalyst, and the third hydrogenation catalyst are placed in a downflow-type fixed bed reaction apparatus,
the first hydrogenation catalyst, the second hydrogenation catalyst, and the third hydrogenation catalyst are different catalysts,
both the first hydrogenation catalyst and the second hydrogenation catalyst include macropores and mesopores,
a pore diameter of the macropores is 50 nm or more,
a pore diameter of the mesopores is less than 50 nm,
a pore distribution (a distribution where a pore volume is plotted against a logarithm of a pore diameter) of the first hydrogenation catalyst has a peak where a pore volume at a pore diameter of 50 nm or more reaches a local maximum and a peak where a pore volume at a pore diameter of less than 50 nm reaches a local maximum,
a pore distribution (a distribution where a pore volume is plotted against a logarithm of a pore diameter) of the second hydrogenation catalyst has a peak where a pore volume at a pore diameter of 50 nm or more reaches a local maximum and a peak where a pore volume at a pore diameter of less than 50 nm reaches a local maximum,
a median pore diameter PD1_{MACRO} of the macropores in the first hydrogenation catalyst is a pore diameter at which a cumulative volume of the macropores in the pore distribution of the first hydrogenation catalyst reaches 50% of the total volume of the macropores,
a median pore diameter PD2_{MACRO} of the macropores in the second hydrogenation catalyst is a pore diameter at which a cumulative volume of the macropores in the pore distribution of the second hydrogenation catalyst reaches 50% of the total volume of the macropores,
the median pore diameter PD1_{MACRO} is larger than the median pore diameter PD2_{MACRO},
a specific surface area of the first hydrogenation catalyst is 185 m²/g or more,
a specific surface area of the second hydrogenation catalyst is 160 m²/g or more, and
a content of a Group 6 element in the second hydrogenation catalyst is 5 mass % or more and 7 mass % or less.
[3] The heavy oil hydroprocessing method according to [2], in which
a volume V1_{MACRO} of the macropores in the first hydrogenation catalyst is larger than a volume V2_{MACRO} of the macropores in the second hydrogenation catalyst.
[4] The heavy oil hydroprocessing method according to [2] or [3], in which
the median pore diameter PD1_{MACRO} is 300 nm or more and 1500 nm or less, and
the median pore diameter PD2_{MACRO} is 100 nm or more and 500 nm or less.
[5] The heavy oil hydroprocessing method according to [1] or [3], in which
the volume V1_{MACRO} is 0.20 ml/g or more and 0.50 ml/g or less, and
the volume V2_{MACRO} is 0.10 ml/g or more and 0.35 ml/g or less.
[6] The heavy oil hydroprocessing method according to any one of [1] to [5], in which
a volume V2_{MESO} of the mesopores in the second hydrogenation catalyst is 0.50 ml/g or more and 0.90 ml/g or less,
a median pore diameter PD2_{MESO} of the mesopores in the second hydrogenation catalyst is a pore diameter at which a cumulative volume of the mesopores in the pore distribution of the second hydrogenation catalyst reaches 50% of the total volume of the mesopores, and
the median pore diameter PD2_{MESO} is 6 nm or more and 20 nm or less.
[7] The heavy oil hydroprocessing method according to any one of [1] to [6], in which
a distribution of the macropores among the pore distribution of each of the first hydrogenation catalyst and the second hydrogenation catalyst is measured by a mercury porosimetry, and
a distribution of the mesopores among the pore distribution of each of the first hydrogenation catalyst and the second hydrogenation catalyst is measured by a nitrogen adsorption method.
[8] The heavy oil hydroprocessing method according to any one of [1] to [7], in which
a content of Group 8 to 10 elements in the second hydrogenation catalyst is 1.0 mass % or more and 3.0 mass % or less, and
a content of phosphorus in the second hydrogenation catalyst is 0.1 mass % or more and 2.0 mass % or less.
[9] The heavy oil hydroprocessing method according to any one of [1] to [8], in which
contents of the Group 6 element and the Group 8 to 10 elements in the second hydrogenation catalyst are larger than contents of the Group 6 element and the Group 8 to 10 elements in the first hydrogenation catalyst, and
a unit of the contents is mass %.
[10] The heavy oil hydroprocessing method according to any one of [1] to [9], in which
a volume of the first hydrogenation catalyst is represented by Vc1,
a volume of the second hydrogenation catalyst is represented by Vc2, and
a volume of the third hydrogenation catalyst is represented by Vc3, and
(Vc1+Vc2)/(Vc1+Vc2+Vc3) is 40 vol % or more and 70 vol % or less, and
(Vc2+Vc3)/(Vc1+Vc2+Vc3) is 60 vol % or more and 95 vol % or less.

### Advantageous Effects of Invention

According to one aspect of the present invention, a heavy oil hydroprocessing method, in which a hydrogenation catalyst has an excellent activity of removing impurities from the heavy oil and the activity of the hydrogenation catalyst is maintained for a long time, is provided.

### BRIEF DESCRIPTION OF DRAWINGS

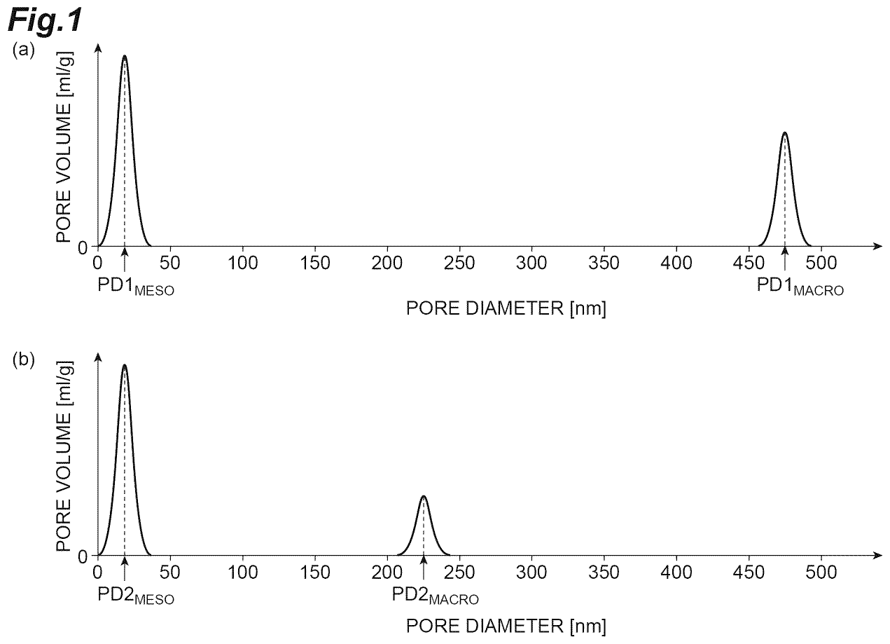

(a) in FIG. 1 is a schematic specific example of a pore distribution of a first hydrogenation catalyst, and (b) in FIG. 1 is a schematic specific example of a pore distribution of a second hydrogenation catalyst.

### DESCRIPTION OF EMBODIMENTS

### [Heavy Oil Hydroprocessing Method]

The inventors have found that a balance between a pore diameter and a pore volume in a macropore region (a region having a pore diameter of 50 nm or more) in a pore distribution of a hydrogenation catalyst is extremely important for performance of removing metal components and asphaltene components in a heavy oil. A macropore basically provides a reaction path for a poorly reactive macromolecule contained in a heavy oil. For example, the poorly reactive macromolecule is a molecule (supramolecule) diffusing in an associated state like an asphaltene component, and a bulky metalloporphyrin molecule (a porphyrin compound containing vanadium or nickel). However, in the case of a normal hydrogenation catalyst (such as a desulfurization catalyst) which does not include macropores, the above-mentioned macromolecule is difficult to diffuse from the surface of a catalyst particle to the inside, and the vicinity of the surface of the catalyst particle extremely greatly contributes to the hydrogenation reaction of the macromolecule. As a result, the deposition of carbonaceous components (coke) and metal components in the vicinity of the surface of the catalyst particle is promoted, and the blockage of a pore (mouth plugging) easily occurs in the vicinity of the outer surface of the catalyst particle, so that the catalyst performance is significantly impaired.

In contrast, in the case of a hydrogenation catalyst including macropores, the macromolecule can easily diffuse from the surface to the inside of the catalyst particle. Therefore, the deposition of carbonaceous components and metal components in the vicinity of the surface of the catalyst particle is suppressed, and the mouth plugging in the vicinity of the outer surface of the catalyst particle is also suppressed. As a result, the effective surface area of the catalyst utilized to remove impurities in the heavy oil increases, and the volume of effective mesopores utilized as a reaction field of macromolecules having diffused into the catalyst particle also increases. Further, suppression of mouth plugging on the surface of the catalyst particle alleviates a decrease in activity (a rapid decrease in activity at the latter stage of the reaction) specific to a hydrodesulfurization catalyst for a heavy oil, and the life of the hydrodesulfurization catalyst is significantly extended.

On the other hand, as the macropores are introduced into the hydrogenation catalyst, the bulk density of the hydrogenation catalyst decreases, and as a result, the mass of the hydrogenation catalyst that can be packed in the reactor (hydroprocessing apparatus) decreases. This means a reduction in initial activity throughout the reactor. Even if the catalyst surface and the reaction field utilized effectively by the introduction of the macropores are increased, and even if the deterioration of the hydrogenation catalyst is greatly alleviated, the reduction in the initial activity of the entire reactor causes a restriction that the temperature of the reactor should be increased from the start of the operation of the reactor.

The reduction in the initial activity throughout the reactor is of course highly dependent on the volume of the macropores introduced into the hydrogenation catalyst. That is, when the volume of the macropores is too large, although the deterioration of each catalyst particle is suppressed, the bulk density of the hydrogenation catalyst decreases, the mass of the hydrogenation catalyst that can be packed in the reactor decreases, and the initial activity of the entire reactor decreases. On the other hand, when the volume of the macropores is too small, the above effect due to the macropores is reduced, and the performance difference between the hydrogenation catalyst including the macropores and the conventional hydrogenation catalyst not including the macropores is reduced. From the above viewpoint, there is an optimum value for the volume of the macropores in the hydrogenation catalyst.

Among impurities in a heavy oil, a metal compound that is relatively easy to react is easily removed from the heavy oil by a demetallization reaction in a hydrogenation catalyst (demetallization catalyst) placed in the vicinity of the inlet of the reactor regardless of the pore structure of the hydrogenation catalyst. On the other hand, a metal compound which is relatively difficult to react among impurities in the heavy oil is hardly removed by the demetallization catalyst and is easy to remain in the heavy oil. When the metal compound which is difficult to react is directly introduced into the hydrodesulfurization catalyst placed at the rear of the demetallization catalyst, since the hydrogenation activity of the hydrodesulfurization catalyst is high and the pore diameter of the hydrodesulfurization catalyst is small, the generation and deposition of a carbonaceous component and a metal derived from a metal component and the blockage of the pores easily proceed on the surface of the hydrodesulfurization catalyst. As a result, the activity of the hydrodesulfurization catalyst rapidly decreases. Therefore, the middle catalyst placed between the former catalyst (demetallization catalyst) and the latter catalyst (hydrodesulfurization catalyst) is required to have a pore structure capable of introducing and diffusing various impurities in the heavy oil into the catalyst and a hydrogenation activity (desulfurization activity) that is not possessed by the former catalyst. In the present embodiment, the former catalyst corresponds to the first hydrogenation catalyst, the middle catalyst corresponds to the second hydrogenation catalyst, and the latter catalyst corresponds to the third hydrogenation catalyst.

As a result of a study based on the above consideration, the inventors have found that the optimum value of the volume V1_{MACRO} of the macropores in the first hydrogenation catalyst is 0.20 ml/g or more and 0.50 ml/g or less, and the optimum value of the volume V2_{MACRO} of the macropores in the second hydrogenation catalyst is 0.10 ml/g or more and 0.35 ml/g or less. That is, the volume V1_{MACRO} of the macropores in the first hydrogenation catalyst is desirably larger than the volume V2_{MACR} of the macropores in the second hydrogenation catalyst. By combining the first hydrogenation catalyst and the second hydrogenation catalyst that satisfy the above conditions, in the hydroprocessing of various heavy oils under various reaction conditions, the initial activity of the entire reactor is hardly impaired, the pores (for example, mesopores) inside each catalyst are easily utilized for the removal of impurities introduced via the macropores, the deterioration of each of the first to third hydrogenation catalysts is alleviated, and the demetallization reaction is easily maintained for a long period of time.

In addition, in consideration of the function of the macropores as reaction paths, there is naturally an optimum pore diameter of the macropores. The larger the molecular weight is, the larger the size of the molecule is. When the polycyclic structure of the molecules in the heavy oil is developed or the heavy oil contains a large amount of polar molecules, the size of the associated molecules formed of these molecules is large. The less compatible the heavy oil and the impurities are, the larger the size of the particles (apparent molecules) formed by aggregation of the impurities is. As the apparent molecular size during diffusion is larger, a macropore with a larger pore diameter is required as a reaction path. In order for the macropore to function as a reaction path, the pore diameter of the macropore is desirably about 5 to 10 times or more the size of the diffusing molecule. As a result of the inventors' study on the actual reactivity of a heavy oil obtained from various types of crude oils, it has been found that the reactivity and diffusibility of impurities in a heavy oil greatly vary depending on the type (production area) of the crude oil or the blending state of the crude oil. (The diffusibility of impurities is estimated from the deposition profile of the metal components in the cross section of the hydrogenation catalyst particle.) That is, it was found that, depending on the type of crude oil or the blending state of the crude oil, various impurities varying in molecular size during diffusion are present in a heavy oil.

As a result of a study based on the above consideration on the apparent molecular size during diffusion, the inventors have found that the optimum value of the median pore diameter PD1_{MACRO} of the macropores in the first hydrogenation catalyst is 300 nm or more and 1500 nm or less (preferably 300 nm or more and 1000 nm or less, more preferably 500 nm or more and 1000 nm or less). When the median pore diameter of the macropores in the first hydrogenation catalyst is within the above range, in the hydroprocessing of various heavy oils under various reaction conditions, the initial activity of the entire reactor (hydroprocessing apparatus) is hardly impaired, the pores (for example, mesopores) in the first hydrogenation catalyst are easily utilized for the removal of impurities introduced via the macropores, the deterioration of each of the first to third hydrogenation catalysts is alleviated, and the demetallization reaction is easily maintained for a long period of time.

After the heavy oil comes into contact with the first hydrogenation catalyst placed in the vicinity of the inlet of the reactor, the molecular size at the time of diffusion of impurities in the heavy oil decreases due to various hydrogenation reactions by the first hydrogenation catalyst. Therefore, in the second hydrogenation catalyst placed downstream (at the rear) of the first hydrogenation catalyst, the pore diameter of the macropores required for diffusion of molecules into the catalyst can be made smaller than the macropore diameter in the first hydrogenation catalyst. That is, by combining the first hydrogenation catalyst in which the pore diameter of the macropores is large and the second hydrogenation catalyst in which the pore diameter of the macropores is small, the total volume of the macropores occupying the space in the reactor as reaction paths is greatly reduced, and the total catalytic activity per unit volume of the first hydrogenation catalyst and the second hydrogenation catalyst is greatly improved. As a result of a study on the pore diameter of the macropores in the second hydrogenation catalyst, the inventors have found that the optimum value of the median pore diameter PD2_{MACRO} of the macropores in the second hydrogenation catalyst is 100 nm or more and 500 nm or less (preferably 150 nm or more and 350 nm or less, more preferably 200 nm or more and 250 nm or less).

As a result of the above consideration and study, the inventors have completed the present invention. Hereinafter, preferred embodiments of the present invention will be described with reference to the drawings. The present invention is not limited to the following embodiments.

The heavy oil hydroprocessing method according to the present embodiment includes a step of sequentially bringing a heavy oil into contact with a first hydrogenation catalyst (former catalyst), a second hydrogenation catalyst (middle catalyst), and a third hydrogenation catalyst (latter catalyst) in the presence of hydrogen. That is, the heavy oil comes into contact with the first hydrogenation catalyst, the heavy oil after coming into contact with the first hydrogenation catalyst comes into contact with the second hydrogenation catalyst, and the heavy oil after coming into contact with the second hydrogenation catalyst comes into contact with the third hydrogenation catalyst. The first hydrogenation catalyst, the second hydrogenation catalyst, and the third hydrogenation catalyst are placed (packed) in a downflow-type fixed bed reaction apparatus. For example, all of the first hydrogenation catalyst, the second hydrogenation catalyst, and the third hydrogenation catalyst may be packed as three catalyst layers in one downflow-type fixed bed reaction apparatus. For example, the first hydrogenation catalyst may be packed in a first downflow-type fixed bed reaction apparatus, the second hydrogenation catalyst may be packed in a second downflow-type fixed bed reaction apparatus, the third hydrogenation catalyst may be packed in a third downflow-type fixed bed reaction apparatus, the first downflow-type fixed bed reaction apparatus may be disposed in the front of the second downflow-type fixed bed reaction apparatus, and the second downflow-type fixed bed reaction apparatus may be disposed in the front of the third downflow-type fixed bed reaction apparatus.

The first hydrogenation catalyst, the second hydrogenation catalyst, and the third hydrogenation catalyst are different catalysts (compositions). The first hydrogenation catalyst is a catalyst (demetallization catalyst) having an excellent demetallization activity. The second hydrogenation catalyst is a catalyst having not only a demetallization activity but also an excellent hydrodesulfurization activity. The third hydrogenation catalyst is a catalyst (hydrodesulfurization catalyst) having an excellent hydrodesulfurization activity. Due to the hydrogenation activity (hydrocracking activity) of each hydrogenation catalyst, hydrocracking of the heavy oil and asphaltene components occurs, and a light fraction having a low molecular weight and a carbonaceous component are produced. Due to the demetallization activity of each of the first hydrogenation catalyst and the second hydrogenation catalyst, a metal component (for example, an organometallic compound containing vanadium, nickel, or the like) in the heavy oil is cracked and removed from the heavy oil. A metal generated by the cracking of the metal component is deposited on the surface of each of the first hydrogenation catalyst and the second hydrogenation catalyst, or accumulated in the pores of each of the first hydrogenation catalyst and the second hydrogenation catalyst. Due to the hydrodesulfurization activity of each of the second hydrogenation catalyst and the third hydrogenation catalyst, a sulfur component in the heavy oil is hydrogenated and removed from the heavy oil as hydrogen sulfide.

(a) in FIG. 1 is a schematic pore distribution of the first hydrogenation catalyst. (b) in FIG. 1 is a schematic pore distribution of the second hydrogenation catalyst. The vertical axis of the pore distribution is the volume of the pores, and the actual horizontal axis of the pore distribution is the logarithm (log₁₀ D) of the pore diameter D. However, in (a) in FIG. 1 and (b) in FIG. 1, the pore diameter D itself is represented on the horizontal axis instead of the logarithm of the pore diameter D in order to make it easier to visually identify the position and size of each peak in each pore distribution and the difference therebetween. That is, each pore distribution is simplified in order to emphasize the feature of each pore distribution in (a) in FIG. 1 and (b) in FIG. 1. The pore distribution of the first hydrogenation catalyst is not limited to the pore distribution shown in (a) in FIG. 1. The pore distribution of the second hydrogenation catalyst is not limited to the pore distribution shown in (b) in FIG. 1.

As shown in (a) in FIG. 1, the horizontal axis of the pore distribution of the first hydrogenation catalyst represents the pore diameter (unit: nm) of the pores in the first hydrogenation catalyst. The vertical axis of the pore distribution of the first hydrogenation catalyst represents the volume (unit: ml/g) of pores in the first hydrogenation catalyst. g in ml/g corresponds to the unit mass of the first hydrogenation catalyst.

As shown in (b) in FIG. 1, the horizontal axis of the pore distribution of the second hydrogenation catalyst represents the pore diameter (unit: nm) of the pores in the second hydrogenation catalyst. The vertical axis of the pore distribution of the second hydrogenation catalyst represents the volume (unit: ml/g) of pores in the first hydrogenation catalyst. g in ml/g corresponds to the unit mass of the second hydrogenation catalyst.

Both the first hydrogenation catalyst and the second hydrogenation catalyst include macropores and mesopores. The macropores are pores having a pore diameter of 50 nm or more. For example, the pore diameter of the macropores may be 50 nm or more and 3000 nm or less. The mesopores are pores having a pore diameter of less than 50 nm. For example, the pore diameter of the mesopores may be 2 nm or more and less than 50 nm. The mercury porosimetry is superior to the nitrogen adsorption method in the resolution of measurement of a pore diameter in the vicinity of 50 nm. That is, measuring the pore diameter in the vicinity of 50 nm by the nitrogen adsorption method is not appropriate in terms of measurement accuracy. Therefore, the distribution of macropores among the pore distributions of each of the first hydrogenation catalyst and the second hydrogenation catalyst may be measured by the mercury porosimetry. The nitrogen adsorption method is superior to the mercury porosimetry in the resolution of measurement of a pore diameter of less than 50 nm. Therefore, the distribution of mesopores among the pore distributions of each of the first hydrogenation catalyst and the second hydrogenation catalyst may be measured by the nitrogen adsorption method.

As shown in (a) in FIG. 1, the pore distribution (actually, the distribution where the pore volume is plotted against the logarithm of the pore diameter) of the first hydrogenation catalyst has a peak at which the pore volume at a pore diameter of 50 nm or more reaches a local maximum and a peak at which the pore volume at a pore diameter of less than 50 nm reaches a local maximum. As shown in (b) in FIG. 1, the pore distribution (actually, the distribution where the pore volume is plotted against the logarithm of the pore diameter) of the second hydrogenation catalyst also has a peak at which the pore volume at a pore diameter of 50 nm or more reaches a local maximum and a peak at which the pore volume at a pore diameter of less than 50 nm reaches a local maximum. That is, both the first hydrogenation catalyst and the second hydrogenation catalyst are bimodal catalysts. The bimodal catalyst is a catalyst in which the pore distribution has at least two peaks (peaks at which the pore volume reaches a local maximum).

The heavy oil hydroprocessing method according to one aspect of the present embodiment has “technical feature 1” that the volume V1_{MACRO} (unit: ml/g) of the macropores in the first hydrogenation catalyst is larger than the volume V2_{MACRO} (unit: ml/g) of the macropores in the second hydrogenation catalyst. For example, the volume V1_{MACRO} may be 0.20 ml/g or more and 0.50 ml/g or less, and the volume V2_{MACRO} may be 0.10 ml/g or more and 0.35 ml/g or less. The volume V1_{MACRO} is paraphrased as the total volume of all the macropores in the first hydrogenation catalyst. The volume V2_{MACRO} is paraphrased as the total volume of all the macropores in the second hydrogenation catalyst.

The heavy oil hydroprocessing method according to another aspect of the present embodiment has “technical feature 2” that the median pore diameter PD1_{MACRO} (unit: nm) of the macropores in the first hydrogenation catalyst is larger than the median pore diameter PD2_{MACRO} (unit: nm) of the macropores in the second hydrogenation catalyst. For example, the median pore diameter PD1_{MACRO} may be 300 nm or more and 1500 nm or less, and the median pore diameter PD2_{MACRO} may be 100 nm or more and 500 nm or less. The median pore diameter PD1_{MACRO} of the macropores in the first hydrogenation catalyst is a pore diameter at which a cumulative volume of the macropores reaches 50% of the total volume of the macropores in the pore distribution of the first hydrogenation catalyst. The median pore diameter PD2_{MACRO} of the macropores in the second hydrogenation catalyst is a pore diameter at which a cumulative volume of the macropores reaches 50% of the total volume of the macropores in the pore distribution of the second hydrogenation catalyst.

The heavy oil hydroprocessing method according to the present embodiment may have both of the technical features 1 and 2. The heavy oil hydroprocessing method according to the present embodiment may have only the technical feature 1 between the technical features 1 and 2. The heavy oil hydroprocessing method according to the present embodiment may have only the technical feature 2 between the technical features 1 and 2.

The technical features 1 and 2 are summarized as a combination of the second hydrogenation catalyst (middle catalyst) being bimodal and including small macropores and mesopores and the first hydrogenation catalyst (former catalyst) being bimodal and including big macropores and mesopores.

Due to the combination of the first hydrogenation catalyst and the second hydrogenation catalyst, even if the hydroprocessing apparatus (reactor) in which the first hydrogenation catalyst, the second hydrogenation catalyst, and the third hydrogenation catalyst are placed is operated at a higher temperature compared to conventional hydroprocessing, the hydrocracking performance, demetallization performance, and hydrodesulfurization performance of the entire hydroprocessing apparatus are less likely to deteriorate, and the hydroprocessing apparatus can be stably operated at a high temperature over a long period of time. For example, according to the present embodiment, the operation of the hydroprocessing apparatus can be continued over 250 days or more, particularly 300 days or more. That is, according to the present embodiment, each of the hydrogen first hydrogenation catalyst, the second hydrogenation catalyst, and the third hydrogenation catalyst has an excellent activity of removing impurities from the heavy oil, and the activity of each hydrogenation catalyst is maintained for a long time. As a result, the performance of removing impurities (particularly metal components) of the entire hydroprocessing apparatus is improved, the cracking rate of the heavy oil is increased, and a larger amount of light fraction can be produced from the heavy oil compared to conventional hydroprocessing.

The volume of the first hydrogenation catalyst is denoted by Vc1 (unit: for example, liter). For example, Vc1 may be the volume of a first catalyst layer consisting of the first hydrogenation catalyst.

The volume of the second hydrogenation catalyst is denoted by Vc2 (unit: for example, liter). For example, Vc2 may be the volume of a second catalyst layer consisting of the second hydrogenation catalyst.

The volume of the third hydrogenation catalyst is denoted by Vc3 (unit: for example, liter). For example, Vc3 may be the volume of a third catalyst layer consisting of the third hydrogenation catalyst.

(Vc1+Vc2)/(Vc1+Vc2+Vc3) may be 40 vol % or more and 70 vol % or less, preferably 50 vol % or more and 70 vol % or less, and more preferably 60 vol % or more and 70 vol % or less.

(Vc2+Vc3)/(Vc1+Vc2+Vc3) may be 60 vol % or more and 95 vol % or less, and preferably 70 vol % or more and 90 vol % or less.

When each of (Vc1+Vc2)/(Vc1+Vc2+Vc3) and (Vc2+Vc3)/(Vc1+Vc2+Vc3) is within the above range, the performance of removing impurities (particularly metal components) of the entire hydroprocessing apparatus is easily improved, and the performance of removing impurities of the entire hydroprocessing apparatus is easily maintained over a long period of time.

For example, the first hydrogenation catalyst, the second hydrogenation catalyst, and the third hydrogenation catalyst may be contained as three catalyst layers in the same reactor (for example, a reaction tower). The first hydrogenation catalyst, the second hydrogenation catalyst, and the third hydrogenation catalyst may be contained in a plurality of different reactors, respectively. Hydrogen (hydrogen gas) may be injected into each hydrogenation catalyst (each catalyst layer). Hydroprocessing of the heavy oil using another catalyst may be performed before the heavy oil comes into contact with the first hydrogenation catalyst. After the heavy oil comes into contact with the third hydrogenation catalyst, hydroprocessing or fluid catalytic cracking of the heavy oil using another catalyst may be performed. The first catalyst layer containing the first hydrogenation catalyst may further contain one or more other catalysts other than the second hydrogenation catalyst and the third hydrogenation catalyst. For example, other catalysts are catalysts that do not have a sufficient function as a catalyst for use in hydroprocessing such as a so-called guard catalyst and a support catalyst. Similarly, the second catalyst layer containing the second hydrogenation catalyst may also further contain one or more other catalysts other than the first hydrogenation catalyst and the third hydrogenation catalyst. The third catalyst layer containing the third hydrogenation catalyst may also further contain one or more other catalysts other than the first hydrogenation catalyst and the second hydrogenation catalyst. When each catalyst layer containing the first hydrogenation catalyst, the second hydrogenation catalyst, or the third hydrogenation catalyst further contains other catalysts described above, Vc1, Vc2, and Vc3 are volumes excluding the other catalysts.

### [First Hydrogenation Catalyst]

The first hydrogenation catalyst (former catalyst) with which the heavy oil first comes into contact needs to remove a large amount of macromolecules, which are relatively easy to react, among the metal components and the asphaltene components. Therefore, in order to promote diffusion of macromolecules into the first hydrogenation catalyst, the pore structure of the first hydrogenation catalyst is extremely important. In addition, when the activity of the first hydrogenation catalyst is too high, generation and deposition of a metal by hydrocracking of a metal component are easily promoted at the inlet of pores opened on the surface of the first hydrogenation catalyst, and the first hydrogenation catalyst is easily deactivated. In order to suppress such deactivation, the content of the active metal in the first hydrogenation catalyst is desirably small.

The volume V1_{MESO} of the mesopores in the first hydrogenation catalyst may be 0.4 ml/g or more and 1.1 ml/g or less, and preferably 0.6 ml/g or more and 1.1 ml/g or less. The volume V1_{MESO} is paraphrased as the total volume of all the mesopores in the first hydrogenation catalyst. When the volume V1_{MESO} is 0.4 ml/g or more, it is easy to suppress a decrease in demetallization activity due to deposition of a metal on the surface of the first hydrogenation catalyst.

The median pore diameter PD1_{MESO} of the mesopores in the first hydrogenation catalyst may be 6 nm or more and 20 nm or less, and preferably 8 nm or more and 15 nm or less. The median pore diameter PD1_{MESO} is a pore diameter at which a cumulative volume of the mesopores reaches 50% of the total volume of the mesopores in the pore distribution of the first hydrogenation catalyst.

The specific surface area of the first hydrogenation catalyst may be 185 m²/g or more and 350 m²/g or less, and preferably 190 m²/g or more and 350 m²/g or less.

A demetallization catalyst that can be industrially used as the first hydrogenation catalyst has restrictions on the specific surface area and the pore volume due to its target performance.

The reason is that the specific surface area of the catalyst is positively correlated with the reaction active point of the catalyst, and the pore diameter and the pore volume affect the mass transfer of a reactant (heavy oil molecule). On the other hand, there is a trade-off relationship that the specific surface area decreases when the pore diameter and pore volume are increased in order to promote the mass transfer of a reactant (heavy oil molecule), as a property of the catalyst. In order to ensure the desired performance of the demetallization catalyst, it is necessary to adopt a catalyst having a high specific surface area. On the other hand, in order to maintain the minimum pore diameter and pore volume, the specific surface area is also restricted, and as a result, there is an upper limit thereof.

As a result of a study and an investigation by the inventors, it has been found that the specific surface area of the first hydrogenation catalyst (demetallization catalyst) exhibiting high performance is 185 m²/g or more and 350 m²/g or less, and preferably 190 m²/g or more and 300 m²/g or less. A case where the specific surface area of the first hydrogenation catalyst is less than 185 m²/g is not preferable because the first hydrogenation catalyst cannot exhibit sufficient performance, and the performance of the entire catalyst system consisting of the first hydrogenation catalyst, the second hydrogenation catalyst, and the third hydrogenation catalyst is impaired.

The volume V1_{MACRO} of the macropores in the first hydrogenation catalyst may be 0.20 ml/g or more and 0.50 ml/g or less, and preferably 0.25 ml/g or more and 0.45 ml/g or less. When the volume V1_{MACRO} is 0.20 ml/g or more, the demetallization activity of the first hydrogenation catalyst is improved. When the volume V1_{MACRO} is 0.50 ml/g or less, the mechanical strength of the first hydrogenation catalyst is improved.

The total volume of pores having a pore diameter of 2000 nm or more in the first hydrogenation catalyst may be 0.1 ml/g or less, and preferably 0.05 ml/g or less. When the total volume of the pores having a pore diameter of 2000 nm or more is 0.1 ml/g or less, the mechanical strength of the first hydrogenation catalyst is improved.

The median pore diameter PD1_{MACRO} of the macropores in the first hydrogenation catalyst may be 300 nm or more and 1500 nm or less, preferably 300 nm or more and 1000 nm or less, and more preferably 500 nm or more and 1000 nm or less.

The first hydrogenation catalyst includes a porous support consisting of an inorganic oxide. All the features related to the pores in the first hydrogenation catalyst are derived from the porous support. That is, the pores in the first hydrogenation catalyst reflect the features of the pores in the porous support constituting the first hydrogenation catalyst. The “first support” described below means a porous support constituting the first hydrogenation catalyst. The first support may be an oxide of one or more elements selected from the group consisting of a Group 2 element, a Group 4 element, a Group 13 element, and a Group 14 element. For example, the first support preferably contains one or more oxides selected from the group consisting of silica, alumina, magnesia, zirconia, boria, and calcia. The first support more preferably contains one or more oxides selected from the group consisting of γ-alumina, δ-alumina, η-alumina, χ-alumina, silica-alumina, silica, alumina-magnesia, silica-magnesia, and alumina-silica-magnesia. The first support is particularly preferably γ-alumina. The content of alumina (Al₂O₃) in the first support may be 50 mass % or more, and preferably 70 mass % or more.

The first hydrogenation catalyst may contain one or more metals selected from the group consisting of a Group 6 element, a Group 8 element, a Group 9 element, and a Group 10 element as metal components (metal components having a hydrogenation activity) supported on the first support. For example, the first hydrogenation catalyst may preferably contain at least one of molybdenum and tungsten. The first hydrogenation catalyst may further contain at least one of nickel and cobalt in addition to at least one of molybdenum and tungsten. The metal component supported on the first support may be a metal, an oxide, or a sulfide. The total content of the Group 6 element, the Group 8 element, the Group 9 element, and the Group 10 element in the first hydrogenation catalyst may be 0.1 mass % or more and 10 mass % or less, preferably 0.5 mass % or less and 6 mass % or less, and more preferably 1 mass % or more and 5 mass % or less. The first hydrogenation catalyst may further contain a compound (for example, an oxide) containing at least one of phosphorus and boron. The total content of phosphorus and boron in the first hydrogenation catalyst may be 0 mass % or more and 3 mass % or less, and preferably 0.1 mass % or more and 1 mass % or less. When the content of each element in the first hydrogenation catalyst is within the above range, the demetallization activity of the first hydrogenation catalyst is improved, an excessive hydrocracking reaction on the surface of the first hydrogenation catalyst is easily suppressed, and deactivation of the first hydrogenation catalyst is easily suppressed.

Hereinafter, an example of a method for preparing the first hydrogenation catalyst will be described.

As a raw material of the first support, a raw material powder containing alumina (including hydrous alumina) such as γ-alumina or pseudoboehmite as a main component is used. The raw material powder may further contain the above-described oxide in addition to γ-alumina or pseudoboehmite. The raw material powder is mixed and kneaded together with a liquid, a molding aid, or the like, and a kneaded material (dough) having a desired water content, hardness, and viscosity is obtained. A molded body is formed by extrusion molding of the kneaded material. The molded body is dried with hot air or the like to lower the water content ratio to an appropriate level, and then calcined to obtain a first support. The content of γ-alumina (excluding adsorbed water) or pseudoboehmite (excluding crystalline water and adsorbed water) in the raw material powder may be 60 mass % or more and 100 mass % or less, and preferably 75% mass % or more and 100 mass % or less.

The total volume of the mesopores in the raw material powder may be 0.6 ml/g or more, and preferably 0.8 ml/g or more. The pore distribution of the mesopores in the raw material powder may be measured by the nitrogen adsorption method. When the total volume of the mesopores in the raw material powder is less than 0.6 ml/g, the volume V1_{MESO} of the mesopores in the first hydrogenation catalyst is reduced, so that the effective metal deposition amount in the first hydrogenation catalyst is reduced.

The average particle diameter (median diameter) of the raw material powder may be preferably 10 μm or more and 300 μm or less, and preferably 10 μm or more and 100 μm or less. The average particle diameter of the raw material powder may be measured by a general laser scattering method under water dispersion. When the average particle diameter of the raw material powder is less than 10 μm, the volume V1_{MACRO} of the macropores in the first hydrogenation catalyst decreases, and thus the demetallization activity of the first hydrogenation catalyst decreases. When the average particle diameter of the raw material powder exceeds 300 μm, the volume of pores having a pore diameter of 2000 nm or more in the first hydrogenation catalyst increases, and thus the mechanical strength of the first hydrogenation catalyst decreases.

The γ-alumina is preferably γ-alumina obtained by calcining pseudoboehmite at 450° C. or higher and 850° C. or lower. A used catalyst (for example, a hydrogenation catalyst in which a metal component is supported on γ-alumina) may be used as a raw material of γ-alumina. The average particle diameter of the raw material powder may be adjusted to a desired value by pulverizing the raw material powder using a ball mill, a roller mill, a jet mill, a pulverizer, or the like. The pore distribution of the first support can be controlled by the average particle diameter of the raw material powder.

The method for molding the raw material powder is not particularly limited. For example, a paste or a clay containing the raw material powder and a liquid (water or organic solvent) may be molded. For example, the molding means may be extrusion molding, pressure molding, application to a processed sheet, or the like. By drying or calcining the raw material powder after being subjected to molding, a support having a desired shape and dimension can be obtained. The raw material powder may be formed into a spherical shape by dispersing a gel-like or slurry-like raw material powder in a gas by spray drying or the like and drying the dispersion. The sol-like or slurry-like raw material powder may be formed into a spherical shape in a liquid. If necessary, a molding aid may be added to the raw material powder. A tablet consisting of the raw material powder may be formed by pressure molding using a tablet machine. The raw material powder may be granulated by rolling granulation.

When the raw material powder and the liquid are mixed, the raw material powder and the liquid may be mixed and kneaded with a general mixer or kneader or the like used for preparing a catalyst. Preferably, the raw material powder and water may be mixed with a stirring blade. As the liquid to be mixed with the raw material powder, an organic solvent such as an alcohol or ketone may be used in place of water. The raw material powder may be mixed with one or more additives such as an acid such as nitric acid, acetic acid, or formic acid, a base such as ammonia, an organic compound (molding aid) such as water-soluble cellulose ether, a surfactant, and an active ingredient. Preferably, a molding aid such as water-soluble cellulose ether may be mixed with the raw material powder. The pore distribution of the first support can be controlled by the concentration of these additives, various conditions of mixing and kneading, a calcining temperature, or the like.

In order to achieve the above features related to the macropores in the first support, the balance between an appropriate water percentage and an amount of a molding aid added is important in the step of mixing and kneading the raw material powder, water, and the molding aid. The water percentage of the raw material mixture (referred to as “dough”) containing the raw material powder, water, and the molding aid may be preferably 53.0 mass % or more and 60.0 mass % or less, and more preferably 54.0 mass % or more and 58.0 mass % or less. The proportion of the mass of the molding aid added to the raw material powder may be preferably 0.5 parts by mass or more and 5 parts by mass or less, and more preferably 1.0 parts by mass or more and 3.0 parts by mass or less with respect to 100 parts by mass of the raw material powder.

A pellet-shaped or honeycomb-shaped molded body may be formed from the raw material mixture using a molding apparatus such as a plunger-type extruder or a screw-type extruder. The molded body may be dried at room temperature or higher and 150° C. or lower, and preferably at 100° C. or higher and 140° C. or lower. The first support may be obtained by calcining the dried molded body at 350° C. or higher and 900° C. or lower, preferably 450° C. or higher and 850° C. or lower for 0.5 hours or more and 5 hours or less.

For example, the shape of the first support may be a sphere, a column, a cylinder, a prism, or a columnar body having a three- or four-leaf clover-shaped cross section. For example, the maximum diameter of the cross section of the first support (the cross section perpendicular to the length direction in the case of a columnar body or a cylindrical body) may be 0.5 mm or more and 6 mm or less. For example, the length of the first support may be arbitrarily adjusted in consideration of handleability.

The first hydrogenation catalyst is obtained by supporting the above-described metal component (a metal component having a hydrogenation activity) on the first support. For example, the method of supporting the metal component on the first support may be an impregnation method, a pore-filling method, a heating impregnation method, a vacuum impregnation method, an immersion method, or the like. For example, the first support impregnated with the metal component may be dried at 80° C. or higher and 200° C. or lower for 10 minutes or more and 24 hours or less. The metal component may be supported on the first support by calcining the dried first support at 400° C. or higher and 600° C. or lower, preferably 450° C. or higher and 550° C. or lower for 15 minutes or more and 10 hours or less. The metal component may be added to the raw material powder described above in the process for producing the first support. For example, a metal component may be added to γ-alumina or pseudoboehmite in advance. The metal component may be added to the raw material powder or the raw material mixture in the process of mixing and kneading the raw material powder. That is, the metal component may be kneaded into the raw material powder in advance. The metal component may be added to the raw material powder or the raw material mixture at the time of molding the raw material powder or the raw material mixture. The metal component may be supported on the molded body during drying or before calcining of the molded body. For example, when a used hydrogenation catalyst is used as a part of the raw material powder, the raw material powder may already contain at least a part of the metal component.

### [Second Hydrogenation Catalyst]

Except for the matters described below, the second hydrogenation catalyst and the method for producing the second hydrogenation catalyst may be similar to the first hydrogenation catalyst and the method for producing the first hydrogenation catalyst described above.

The second hydrogenation catalyst (middle catalyst) placed at the rear of the first hydrogenation catalyst removes impurities (components having relatively poor reactivity among the metal components and the asphaltene components) that are hardly removed by the first hydrogenation catalyst. For this purpose, the content of a metal component (a metal component having a hydrogenation activity) in the second hydrogenation catalyst is desirably larger than the content of a metal component (a metal component having a hydrogenation activity) in the first hydrogenation catalyst. As described above, since macromolecules among impurities are easily removed through the macropores in the first hydrogenation catalyst, the volume V2_{MACRO} and the median pore diameter PD2_{MACRO} of the macropores (pores for diffusion of impurity molecules) in the second hydrogenation catalyst may be slightly smaller than the volume V1_{MACRO} and the median pore diameter PD1_{MACRO} of the macropores in the first hydrogenation catalyst.

The volume V2_{MESO} of the mesopores in the second hydrogenation catalyst may be 0.50 ml/g or more and 0.90 ml/g or less, preferably 0.55 ml/g or more and 0.85 ml/g or less, and more preferably 0.60 ml/g or more and 0.80 ml/g or less. The volume V2_{MESO} is paraphrased as the total volume of all the mesopores in the second hydrogenation catalyst.

The median pore diameter PD2_{MESO} of the mesopores in the second hydrogenation catalyst may be 6 nm or more and 20 nm or less, and preferably 8 nm or more and 15 nm or less. The median pore diameter PD2_{MESO} is a pore diameter at which a cumulative volume of the mesopores reaches 50% of the total volume of the mesopores in the pore distribution of the second hydrogenation catalyst.

When the second hydrogenation catalyst has the above-described features related to the mesopores, the demetallization activity and the hydrodesulfurization activity of the second hydrogenation catalyst are easily improved, and the life of the second hydrogenation catalyst is easily extended.

The specific surface area of the second hydrogenation catalyst may be 160 m²/g or more and 300 m²/g or less, and preferably 170 m²/g or more and 250 m²/g or less.

A transition catalyst that can be industrially used as the second hydrogenation catalyst has restrictions on the specific surface area and the pore volume due to its target performance.

The reason is that the specific surface area of the catalyst is positively correlated with the reaction active point of the catalyst, and the pore diameter and the pore volume affect the mass transfer of a reactant (heavy oil molecule) as with the first hydrogenation catalyst. On the other hand, there is a trade-off relationship that the specific surface area decreases when the pore diameter and pore volume are increased in order to promote the mass transfer of a reactant (heavy oil molecule) as a property of the catalyst. As a result, in order to ensure the desired performance as the second hydrogenation catalyst, it is necessary to adopt a catalyst having a high specific surface area while naturally maintaining the minimum pore diameter and pore volume.

As a result of a study and an investigation by the inventors, it has been found that the specific surface area of the second hydrogenation catalyst (transition catalyst) exhibiting high performance is 160 m²/g or more and 300 m²/g or less, and preferably 170 m²/g or more and 250 m²/g or less. A case where the specific surface area of the second hydrogenation catalyst is less than 160 m²/g is not preferable because the second hydrogenation catalyst cannot exhibit sufficient performance, and the performance of the entire catalyst system consisting of the first hydrogenation catalyst, the second hydrogenation catalyst, and the third hydrogenation catalyst is impaired.

The volume V2_{MACRO} of the macropores in the second hydrogenation catalyst may be 0.10 ml/g or more and 0.35 ml/g or less, and preferably 0.15 ml/g or more and 0.30 ml/g or less. When the volume V2_{MACRO} is 0.35 ml/g or less, the demetallization activity and the hydrodesulfurization activity of the second hydrogenation catalyst are easily improved, and the mechanical strength of the second hydrogenation catalyst is improved.

The total volume of pores having a pore diameter of 2000 nm or more in the second hydrogenation catalyst may be 0.1 ml/g or less, and preferably 0.05 ml/g or less. When the total volume of the pores having a pore diameter of 2000 nm or more is 0.1 ml/g or less, the mechanical strength of the second hydrogenation catalyst is improved.

The median pore diameter PD2_{MACRO} of the macropores in the second hydrogenation catalyst may be 100 nm or more and 500 nm or less, preferably 150 nm or more and 350 nm or less, and more preferably 200 nm or more and 250 nm or less.

The second hydrogenation catalyst includes a porous support consisting of an inorganic oxide. All the features related to the pores in the second hydrogenation catalyst are derived from the porous support. That is, the pores in the second hydrogenation catalyst reflect the features of the pores in the porous support constituting the second hydrogenation catalyst. The “second support” described below means a porous support constituting the second hydrogenation catalyst. Except for the pore distribution in the second support, the second support may be similar to the first support described above. The second support may be an oxide of one or more elements selected from the group consisting of a Group 2 element, a Group 4 element, a Group 13 element, and a Group 14 element. For example, the second support preferably contains one or more oxides selected from the group consisting of silica, alumina, magnesia, zirconia, boria, and calcia. The second support more preferably contains one or more oxides selected from the group consisting of γ-alumina, δ-alumina, η-alumina, χ-alumina, silica-alumina, silica, alumina-magnesia, silica-magnesia, and alumina-silica-magnesia. The second support is particularly preferably γ-alumina. The content of alumina (Al₂O₃) in the second support may be 50 mass % or more, and preferably 70 mass % or more.

Examples of the method for controlling the second support to have a desired pore distribution include reduction of the amount of water to be mixed with the raw material powder in the second support preparation step, optimization of the amount of a molding aid, an increase in a kneading strength (such as a shear force during kneading or a kneading time), and optimization of molding conditions (such as the type of a molding machine and a molding pressure) within an appropriate range of the particle diameter (described later) of the raw material powder. In particular, in the production of the second support, the amount of water to be mixed with the mixed powder is adjusted to be smaller than that of the first support, so that the volume of the macropores formed in the second support decreases due to evaporation of the water in the dough of the raw material mixture (dough). In addition, since the amount of water in the dough is small, the dough is hard and the handleability is improved, and there is also an advantage that the productivity in extrusion molding is excellent.

The second hydrogenation catalyst may contain one or more metals selected from the group consisting of a Group 6 element, a Group 8 element, a Group 9 element, and a Group 10 element as metal components (metal components having a hydrogenation activity) supported on the second support. For example, the second hydrogenation catalyst may preferably contain at least one of molybdenum and tungsten. The second hydrogenation catalyst may further contain at least one of nickel and cobalt in addition to at least one of molybdenum and tungsten. The metal component supported on the second support may be a metal, an oxide, or a sulfide.

The content of the Group 6 element in the second hydrogenation catalyst may be 5.0 mass % or more and 7.0 mass % or less, preferably 5.2 mass % or more and 6.8 mass % or less, and more preferably 5.4 mass % or more and 6.6 mass % or less.

The total content of the Group 8 to 10 elements in the second hydrogenation catalyst may be 1.0 mass % or more and 3.0 mass % or less, and preferably 1.2 mass % or more and 2.8 mass % or less.

The second hydrogenation catalyst may further contain a compound (for example, an oxide) containing at least one of phosphorus and boron. The total content of phosphorus and boron in the second hydrogenation catalyst may be 0.1 mass % or more and 2.0 mass % or less, preferably 0.2 mass % or more and 1.5 mass % or less, and more preferably 0.3 mass % or more and 1.3 mass % or less.

When the content of each element in the second hydrogenation catalyst is within the above range, the demetallization activity and the hydrodesulfurization activity of the second hydrogenation catalyst are easily improved.

In particular, the content of the Group 6 element in the second hydrogenation catalyst less than 5.0 mass % is not preferable because it is difficult for the second hydrogenation catalyst to exhibit the desulfurization-demetallization performance to be expected.

In addition, the content of the Group 6 element in the second hydrogenation catalyst exceeding 7.0 mass % is not preferable because the desulfurization-demetallization performance of the second hydrogenation catalyst exceeds its expected performance, and accordingly, the progress of poisoning of the catalyst is accelerated, resulting in deterioration in performance of the entire catalyst system consisting of the first hydrogenation catalyst, the second hydrogenation catalyst, and the third hydrogenation catalyst.

Basically, the order and combination of the catalyst system to be packed in the reaction apparatus are determined such that the pore diameter and pore volume decrease, the specific surface area increases, and the content of the active metal (particularly the Group 6 element) increases in the order of the first hydrogenation catalyst, the second hydrogenation catalyst, and the third hydrogenation catalyst. It depends on changes in properties, molecular structure, and the like of the heavy oil (reactant) to be treated from the inlet to the outlet of the catalyst tower, and depends on changes in the required catalytic activity level and poisoning resistance.

From such a viewpoint, there is an optimum value of the content of the active metal (particularly the Group 6 element) in the second hydrogenation catalyst from the viewpoint of the balance with the former and latter catalysts.

The contents (unit: mass %) of the Group 6 element and the Group 8 to 10 elements in the second hydrogenation catalyst may be larger than the contents of the Group 6 element and the Group 8 to 10 elements in the first hydrogenation catalyst. When the contents (unit: mass %) of the Group 6 element and the Group 8 to 10 elements in the second hydrogenation catalyst are larger than the contents of the Group 6 element and the Group 8 to 10 elements in the first hydrogenation catalyst, the demetallization activity and the hydrodesulfurization activity of the second hydrogenation catalyst are improved, and as a result, an excessive hydrocracking reaction on the surface of the subsequent third hydrogenation catalyst is easily suppressed, and deactivation of the third hydrogenation catalyst is easily suppressed.

Hereinafter, an example of a method for preparing the second hydrogenation catalyst will be described. Except for the matters described below, the method for preparing the second hydrogenation catalyst may be similar to the method for preparing the first hydrogenation catalyst described above although consideration and change in conditions for controlling the macropore distribution are needed.

As a raw material of the second support, a raw material powder containing alumina (including hydrous alumina) such as γ-alumina or pseudoboehmite as a main component is used. The raw material powder may further contain the above-described oxide in addition to γ-alumina or pseudoboehmite. The raw material powder is mixed and kneaded together with a liquid, a molding aid, or the like, and a kneaded material (dough) having a desired water content, hardness, and viscosity is obtained. A molded body is formed by extrusion molding of the kneaded material. The molded body is dried with hot air or the like to lower the water content ratio to an appropriate level, and then calcined to obtain a second support. The content of γ-alumina (excluding adsorbed water) or pseudoboehmite (excluding crystalline water and adsorbed water) in the raw material powder may be 60 mass % or more and 100 mass % or less, and preferably 75% mass % or more and 100 mass % or less.

The total volume of the mesopores in the raw material powder may be 0.6 ml/g or more, and preferably 0.8 ml/g or more. The pore distribution of the mesopores in the raw material powder may be measured by the nitrogen adsorption method. When the total volume of the mesopores in the raw material powder is less than 0.6 ml/g, the volume V2_{MESO} of the mesopores in the first hydrogenation catalyst is reduced, so that the effective metal deposition amount in the second hydrogenation catalyst is reduced.

The average particle diameter (median diameter) of the raw material powder may be preferably 10 μm or more and 300 μm or less. The average particle diameter of the raw material powder may be measured by a general laser scattering method under water dispersion. When the average particle diameter of the raw material powder is less than 10 μm, the volume V2_{MACRO} of the macropores in the second hydrogenation catalyst decreases, and thus the demetallization activity of the second hydrogenation catalyst decreases. When the average particle diameter of the raw material powder exceeds 300 μm, the volume of pores having a pore diameter of 2000 nm or more in the second hydrogenation catalyst increases, and thus the mechanical strength of the second hydrogenation catalyst decreases.

It is most preferable that the raw material powder for the second support consists of pseudoboehmite. However, the raw material powder for the second support may further contain γ-alumina in addition to pseudoboehmite. A used catalyst (for example, a hydrogenation catalyst in which a metal component is supported on γ-alumina) may be used as a raw material of γ-alumina. The average particle diameter of the raw material powder may be adjusted to a desired value by pulverizing the raw material powder using a ball mill, a roller mill, a jet mill, a pulverizer, or the like. The pore distribution of the second support can be controlled by the average particle diameter of the raw material powder. The average particle diameter of the raw material powder for the second support may be equal to or slightly smaller than the average particle diameter of the raw material powder for the first support.

The raw material powder and the liquid are preferably mixed and kneaded before molding the raw material powder. The raw material powder and the liquid may be mixed with a general mixer or kneader or the like used for preparing a catalyst. Preferably, the raw material powder and water may be mixed with a stirring blade. As the liquid to be mixed with the raw material powder, an organic solvent such as an alcohol or ketone may be used in place of water. The raw material powder may be mixed with one or more additives such as an acid such as nitric acid, acetic acid, or formic acid, a base such as ammonia, an organic compound (molding aid) such as water-soluble cellulose ether, a surfactant, and an active ingredient. Preferably, a molding aid such as water-soluble cellulose ether may be mixed with the raw material powder. The pore distribution of the second support can be controlled by the concentration of these additives, various conditions of mixing and kneading, a calcining temperature, or the like.

In order to achieve the above features related to the macropores in the second support, the balance between an appropriate water percentage and an amount of a molding aid added is important in the step of mixing and kneading the raw material powder, water, and the molding aid. The water percentage of the raw material mixture (dough) containing the raw material powder, water, and the molding aid may be preferably 51.0 mass % or more and 56.0 mass % or less, and more preferably 53.0 mass % or more and 55.0 mass % or less. The proportion of the mass of the molding aid added to the raw material powder may be preferably 0.1 parts by mass or more and 5 parts by mass or less, and more preferably 0.3 parts by mass or more and 3.0 parts by mass or less with respect to 100 parts by mass of the raw material powder.

For example, the shape of the second support may be a sphere, a column, a cylinder, a prism, or a columnar body having a three- or four-leaf clover-shaped cross section. For example, the maximum diameter of the cross section of the second support (the cross section perpendicular to the length direction in the case of a columnar body or a cylindrical body) may be 0.5 mm or more and 6 mm or less. For example, the length of the second support may be arbitrarily adjusted in consideration of handleability.

### [Third Hydrogenation Catalyst]

The volume V3_{MESO} of the mesopores in the third hydrogenation catalyst may be 0.5 ml/g or more and 1.0 ml/g or less, and preferably 0.6 ml/g or more and 1.0 ml/g or less.

The median pore diameter PD3_{MESO} of the mesopores in the third hydrogenation catalyst may be 5 nm or more and 15 nm or less, and preferably 7 nm or more and 13 nm or less. The median pore diameter PD3_{MESO} is a pore diameter at which a cumulative volume of the mesopores reaches 50% of the total volume of the mesopores in the pore distribution of the third hydrogenation catalyst.

The specific surface area of the third hydrogenation catalyst may be 150 m²/g or more and 350 m²/g or less.

The volume V3_{MACRO} of the macropores in the third hydrogenation catalyst may be 0.2 ml/g or less, and preferably 0.1 ml/g or less. When the volume V3_{MACRO} is 0.2 ml/g or less, the hydrodesulfurization activity and the mechanical strength of the third hydrogenation catalyst are easily improved.

The third hydrogenation catalyst includes a porous support consisting of an inorganic oxide. All the features related to the pores in the third hydrogenation catalyst are derived from the porous support. That is, the features of the pores in the porous support constituting the third hydrogenation catalyst are reflected in the pores in the third hydrogenation catalyst. The “third support” described below means a porous support constituting the third hydrogenation catalyst. Except for the pore distribution in the third support, the third support may be similar to the first support described above. The third support may be an oxide of one or more elements selected from the group consisting of a Group 2 element, a Group 4 element, a Group 13 element, and a Group 14 element. For example, the third support preferably contains one or more oxides selected from the group consisting of silica, alumina, magnesia, zirconia, boria, and calcia. The third support more preferably contains one or more oxides selected from the group consisting of γ-alumina, δ-alumina, η-alumina, χ-alumina, silica-alumina, silica, alumina-magnesia, silica-magnesia, and alumina-silica-magnesia.

The third hydrogenation catalyst may contain one or more metals selected from the group consisting of a Group 6 element, a Group 8 element, a Group 9 element, and a Group 10 element as metal components (metal components having a hydrogenation activity) supported on the third support. For example, the third hydrogenation catalyst may preferably contain at least one of molybdenum and tungsten. The third hydrogenation catalyst may further contain at least one of nickel and cobalt in addition to at least one of molybdenum and tungsten. The metal component supported on the third support may be a metal, an oxide, or a sulfide. The total content of the Group 6 element, the Group 8 element, the Group 9 element, and the Group 10 element in the third hydrogenation catalyst may be 3 mass % or more and 25 mass % or less, preferably 5 mass % or more and 20 mass % or less, and more preferably 7 mass % or more and 17 mass % or less. The third hydrogenation catalyst may further contain a compound (for example, an oxide) containing at least one of phosphorus and boron. The total content of phosphorus and boron in the third hydrogenation catalyst may be 0 mass % or more and 5 mass % or less, and preferably 0.5 mass % or more and 3 mass % or less. When the content of each element in the third hydrogenation catalyst is within the above range, the hydrodesulfurization activity of the third hydrogenation catalyst is easily improved.

Hereinafter, an example of a method for preparing the third hydrogenation catalyst will be described. Except for the matters described below, the method for preparing the third hydrogenation catalyst may be similar to the methods for preparing the first hydrogenation catalyst and the second hydrogenation catalyst described above although consideration such as selection of raw materials and change in preparation conditions for adjusting the supported metal composition is needed.

As a raw material of the third support, a raw material powder containing pseudoboehmite as a main component may be used. The raw material powder is mixed with a liquid, and a molded body is formed through steps such as kneading and molding. The third support is obtained by drying or calcining the molded body. The raw material powder and the liquid are preferably mixed before molding the raw material powder. The raw material powder and the liquid may be mixed and kneaded with a general mixer or kneader or the like used for preparing a catalyst. Preferably, the raw material powder and water may be mixed with a stirring blade. As the liquid to be mixed with the raw material powder, an organic solvent such as an alcohol or ketone may be used in place of water. The raw material powder may be mixed with one or more additives such as an acid such as nitric acid, acetic acid, or formic acid, a base such as ammonia, an organic compound (molding aid) such as water-soluble cellulose ether, a surfactant, and an active ingredient. The pore distribution of the third support can be controlled by the concentration of these additives, various conditions of mixing and kneading, a calcining temperature, or the like.

For example, the shape of the third support may be a sphere, a column, a cylinder, a prism, or a columnar body having a three- or four-leaf clover-shaped cross section. For example, the maximum diameter of the cross section of the third support (the cross section perpendicular to the length direction in the case of a columnar body or a cylindrical body) may be 0.5 mm or more and 6 mm or less. For example, the length of the third support may be arbitrarily adjusted in consideration of handleability.

### [Heavy Oil]

The heavy oil contains, as a main component, a fraction having a boiling point of 360° C. or higher. For example, the content of the fraction having a boiling point of 360° C. or higher in the heavy oil may be 50 vol % or more, more preferably 70 vol % or more, and still more preferably 90 vol % or more. For example, the heavy oil may be various heavy fractions or residual oils obtained by atmospheric distillation or vacuum distillation of a raw material oil. A fraction obtained by a treatment such as a cracking reaction, an isomerization reaction, a reforming reaction, or solvent extraction of a heavy fraction or a residual oil may be used as the heavy oil. For example, the raw material oil may be crude oil, tar sand, shale oil, coal-liquefied oil, or the like. For example, according to the present embodiment, a heavy oil containing a metal component of 10 mass ppm or more, or 50 mass ppm or more in terms of mass of metal elements such as vanadium and nickel can be subjected to hydroprocessing.

The present invention is not necessarily limited to the above-described embodiments. Various modifications of the present invention can be made without departing from the gist of the present invention, and such modifications are also included in the present invention.

### EXAMPLES

The present invention will be described in detail by the following examples and comparative examples. The present invention is not limited by the following examples.

### [Second Hydrogenation Catalyst]

The second hydrogenation catalyst was prepared by the following method.

By kneading 1.5 kg of a commercially available pseudoboehmite powder (hydrated alumina Versal-250, manufactured by UOP), about 1400 ml of ion exchanged water, and 10 g of water-soluble cellulose ether, a raw material mixture having a dough water percentage of 54 mass % was obtained by adjustment with ion exchanged water as appropriate. The content of crystalline water in the pseudoboehmite powder was 18 mass %. The content of adsorbed water in the pseudoboehmite powder was 12 mass %. By extrusion molding of the raw material mixture, a large number of columnar bodies having a four-leaf clover-shaped cross section were formed, and a molded body (pellet) was obtained. The maximum outer diameter of the cross section (four-leaf clover-like shape) was 1.9 mm. The molded body was dried at 130° C. for 15 hours, and then calcined at 800° C. for 1 hour under air flow to obtain a second support for a second hydrogenation catalyst. The second support consisted of porous γ-alumina. The second support was impregnated with an acidic aqueous solution containing molybdenum, nickel, and phosphorus by a spray method. After impregnation with the acidic aqueous solution, the second support was dried at 130° C. for 20 hours. After drying the second support, the second support was calcined at 450° C. for 25 minutes under an air stream to obtain a second hydrogenation catalyst. The content of molybdenum in the second hydrogenation catalyst was 6.0 mass %. The content of nickel in the second hydrogenation catalyst was 1.5 mass %. The content of phosphorus in the second hydrogenation catalyst was 1.0 mass %.

The pore distribution of the second hydrogenation catalyst was measured. The distribution of mesopores in the second hydrogenation catalyst and the specific surface area were measured by the nitrogen adsorption method. The distribution of the macropores in the second hydrogenation catalyst was measured by the mercury porosimetry.

The pore distribution (the distribution where the pore volume is plotted against the logarithm of the pore diameter) of the second hydrogenation catalyst had a peak at which the pore volume at a pore diameter of 50 nm or more reaches a local maximum and a peak at which the pore volume at a pore diameter of less than 50 nm reaches a local maximum. That is, the second hydrogenation catalyst was a bimodal catalyst including macropores and mesopores.

The volume V2_{MESO} of the mesopores in the second hydrogenation catalyst was 0.68 ml/g.

The median pore diameter PD2_{MESO} of the mesopores in the second hydrogenation catalyst was 13.6 nm.

The specific surface area of the second hydrogenation catalyst was 183 m²/g.

The volume V2_{MACRO} of the macropores in the second hydrogenation catalyst was 0.19 ml/g.

The median pore diameter PD2_{MACRO} of the macropores in the second hydrogenation catalyst was 250 nm.

The volume of pores having a pore diameter of 2000 nm or more in the second hydrogenation catalyst was less than 0.01 ml/g.

### [Conventional Middle Catalyst]

As a comparative object of the second hydrogenation catalyst, a conventional middle catalyst (hydrogenation catalyst) was used. The conventional middle catalyst was prepared in the same manner as the second hydrogenation catalyst except that 2 kg of a pseudoboehmite powder (hydrated alumina Versal-250, manufactured by UOP), 1 L of 1 mass % ammonia water, and 0.9 L of water were used as raw materials, and the dough water percentage was set to 52 mass %.

The pore distribution of the conventional middle catalyst was measured in the same manner as that of the second hydrogenation catalyst.

The volume of the mesopores in the conventional middle catalyst was 0.77 ml/g.

The median pore diameter of the mesopores in the conventional middle catalyst was 16.5 nm.

The specific surface area of the conventional middle catalyst was 165 m²/g.

The volume of the macropores in the conventional middle catalyst was less than 0.01 ml/g.

The volume of pores having a pore diameter of 2000 nm or more in the conventional middle catalyst was less than 0.01 ml/g.

As described above, the conventional middle catalyst did not include macropores. Except for the above-mentioned matters related to the pores and the specific surface area, the conventional middle catalyst was almost the same as the second hydrogenation catalyst.

### [First Hydrogenation Catalyst]

The first hydrogenation catalyst was prepared by the following method.

By kneading 450 g of a commercially available pseudoboehmite powder (hydrated alumina Versal-250, manufactured by UOP), 12 g of water-soluble cellulose ether, and 539 g of an ammonia molybdenum aqueous solution (molybdenum: 1.84 mass %), a raw material mixture (dough) having a dough water percentage of 56 mass % was obtained by adjustment with ion exchanged water as appropriate. By extrusion molding of the raw material mixture, a large number of columnar bodies having a four-leaf clover-shaped cross section were formed, and a molded body (pellet) was obtained. The content of crystalline water in the pseudoboehmite powder was 18 mass %. The content of adsorbed water in the pseudoboehmite powder was 12 mass %. The maximum outer diameter of the cross section (four-leaf clover-like shape) of the molded body was 1.9 mm. The molded body was dried at 130° C. for 15 hours, and then calcined at 800° C. for 1 hour under air flow to obtain a first hydrogenation catalyst.

The content of molybdenum in the first hydrogenation catalyst was 3.0 mass %.

The pore distribution of the first hydrogenation catalyst was measured in the same manner as for the second hydrogenation catalyst.

The pore distribution (the distribution where the pore volume is plotted against the logarithm of the pore diameter) of the first hydrogenation catalyst had a peak at which the pore volume at a pore diameter of 50 nm or more reaches a local maximum and a peak at which the pore volume at a pore diameter of less than 50 nm reaches a local maximum. That is, the first hydrogenation catalyst was a bimodal catalyst including macropores and mesopores.

The volume V1_{MESO} of the mesopores in the first hydrogenation catalyst was 0.77 ml/g.

The median pore diameter PD1_{MESO} of the mesopores in the first hydrogenation catalyst was 9.1 nm.

The specific surface area of the first hydrogenation catalyst was 248 m²/g.

The volume V1_{MACRO} of the macropores in the first hydrogenation catalyst was 0.31 ml/g.

The median pore diameter PD1_{MACRO} of the macropores in the first hydrogenation catalyst was 800 nm.

The volume of pores having a pore diameter of 2000 nm or more in the first hydrogenation catalyst was less than 0.01 ml/g.

The volume V1_{MACRO} of the macropores in the first hydrogenation catalyst was larger than the volume V2_{MACRO} of the macropores in the second hydrogenation catalyst.

The median pore diameter PD1_{MACRO} of the macropores in the first hydrogenation catalyst was larger than the median pore diameter PD2_{MACRO} of the macropores in the second hydrogenation catalyst.

### [Third Hydrogenation Catalyst]

The third hydrogenation catalyst was prepared by the following method.

By kneading 2 kg of a commercially available pseudoboehmite powder (a 7:3 mixture of hydrated alumina Catapal-C1 manufactured by SASOL and hydrated alumina Versal-250 manufactured by UOP), about 2000 ml of ion exchanged water, and 61.5 g of nitric acid, a raw material mixture (dough) having a dough water percentage of 52 mass % was obtained. By extrusion molding of the raw material mixture, a large number of columnar bodies were formed, and a molded body (pellet) was obtained. The outer diameter of the cross section (circular shape) of the molded body was 1.0 mm. The molded body was dried at 130° C. for 15 hours, and then calcined at 600° C. for 1 hour under air flow to obtain a third support. The third support was impregnated with a molybdic acid aqueous solution by a spray method and dried, and then further impregnated with a nickel nitrate aqueous solution by a spray method and dried. Thereafter, calcining was performed at 500° C. for 30 minutes under air flow to obtain a third hydrogenation catalyst.

The third support (a support for the third hydrogenation catalyst) consisted of porous γ-alumina.

The content of molybdenum in the third hydrogenation catalyst was 8.0 mass %.

The content of nickel in the third hydrogenation catalyst was 2.2 mass %.

The pore distribution of the third hydrogenation catalyst was measured in the same manner as that of the second hydrogenation catalyst.

The volume V3_{MESO} of the mesopores in the third hydrogenation catalyst was 0.62 ml/g.

The median pore diameter PD3_{MESO} of the mesopores in the third hydrogenation catalyst was 9.1 nm.

The specific surface area of the third hydrogenation catalyst was 231 m²/g.

The volume V3_{MACRO} of the macropores in the third hydrogenation catalyst was less than 0.01 ml/g.

The volume of pores having a pore diameter of 2000 nm or more in the third hydrogenation catalyst was less than 0.01 ml/g.

As described above, the third hydrogenation catalyst did not include macropores.

A sulfidation treatment of each of the first hydrogenation catalyst, the second hydrogenation catalyst, the conventional middle catalyst, and the third hydrogenation catalyst was performed before hydroprocessing of the heavy oil described later was performed. In the sulfidation treatment of each catalyst, each catalyst was brought into contact with a non-aromatic hydrocarbon oil in which 1 vol % of dimethyl disulfide was dissolved.

### [Heavy Oil]

As the heavy oil, a mixed oil A and a mixed oil B were used. The mixed oil A was a mixed oil consisting of an atmospheric residue (AR) and a vacuum residue (VR). The mixed oil B was a mixed oil consisting of an atmospheric residue and a deasphalted oil. The deasphalted oil is a fraction obtained by removing the asphaltene component from a vacuum residue by solvent extraction. The density of each of the mixed oil A and the mixed oil B is shown in Table 1 below. The contents of the respective impurities in each of the mixed oil A and the mixed oil B are shown in Table 1 below.

TABLE 1

| | | | Mixed | Mixed |
|---|---|---|---|---|
| | | Unit | oil A | oil B |
| Density | | g/cm³ | 0.9885 | 0.9756 |
| Impurities | Sulfur components | mass % | 3.64 | 3.02 |
| | Nitrogen components | mass % | 0.238 | 0.35 |
| | Vanadium | mass ppm | 69.7 | 30.9 |
| | Nickel | mass ppm | 34.8 | 15.4 |
| | Residual carbon components | mass % | 14.1 | 10.3 |
| | Asphaltene components | mass % | 4.8 | 2.1 |

### [Heavy Oil Hydroprocessing]

### Example 1

Hydroprocessing of Example 1 was performed by the following method.

The hydroprocessing apparatus had three cylindrical reactors (former reactor, middle reactor, and latter reactor). Each of the former reactor, the middle reactor, and the latter reactor was a downflow-type fixed bed reaction apparatus. The length of each reactor was 1000 mm and the inner diameter of each reactor was 25 mm. The former reactor communicated with the middle reactor and the middle reactor communicated with the latter reactor. The first hydrogenation catalyst was packed in the former reactor, the second hydrogenation catalyst was packed in the middle reactor, and the third hydrogenation catalyst was packed in the latter reactor. The proportion of the volume (unit: vol %) of the catalyst layer of each of the first hydrogenation catalyst, the second hydrogenation catalyst, and the third hydrogenation catalyst is shown in Table 2 below. In the hydroprocessing of Example 1, the mixed oil A was used as the heavy oil. The heavy oil was supplied to the former reactor, the heavy oil having come into contact with the first hydrogenation catalyst in the former reactor was supplied to the middle reactor, and the heavy oil having come into contact with the second hydrogenation catalyst in the middle reactor was supplied to the latter reactor. The produced oil was recovered from the outlet of the latter reactor.

During the hydroprocessing, hydrogen gas was continuously supplied to each reactor. The hydrogen partial pressure in each reactor was maintained at 14.4 MPa. During hydroprocessing, the hydrogen/oil ratio was maintained at 800 L/L. During hydroprocessing, the liquid hourly space velocity was maintained at 0.45 hr⁻¹.

The temperature of each reactor (each catalyst layer) during hydroprocessing was continuously adjusted so that the sulfur component content in the produced oil (a fraction having a boiling point of 360° C. or higher) was maintained at 0.35 mass %. In order to keep the content of impurities in the produced oil constant, it is necessary to compensate the activity of each hydrogenation catalyst by increasing the reaction temperature (temperature of each hydrogenation catalyst layer) as each hydrogenation catalyst becomes deactivated. Therefore, as the temperature rise of each reactor (each catalyst layer) with the lapse of time during hydroprocessing is smaller, deactivation of each hydrogenation catalyst is suppressed, and an excellent activity of each hydrogenation catalyst for removing impurities in the heavy oil is maintained.

The temperature at the inlet of the middle reactor (second hydrogenation catalyst layer) was maintained at a temperature equal to the temperature at the outlet of the former reactor (first hydrogenation catalyst layer). The temperature at the inlet of the latter reactor (third hydrogenation catalyst layer) was maintained at a temperature lower by 5° C. than the temperature at the outlet of the middle reactor (second hydrogenation catalyst layer). The temperature at the inlet of the former reactor (first hydrogenation catalyst layer) at the start of hydroprocessing was adjusted to about 340° C. to 360° C. so as to adjust the sulfur component content in the produced oil at the target value.

By continuing the above hydroprocessing of the heavy oil, various items shown in Table 2 below were measured.

The “reaction temperature at 300 days” in Table 2 below refers to the average of the temperatures (CAT; Catalyst Average Temperature) of all reactors (all catalyst layers) when 300 days have elapsed from the start of hydroprocessing. The lower the “reaction temperature at 300 days” is, the better activity of each hydrogenation catalyst to remove impurities in the heavy oil is maintained.

“[V] at 300 days” in Table 2 below refers to the content of vanadium in the produced oil (a fraction having a boiling point of 360° C. or higher) when 300 days have elapsed from the start of hydroprocessing.

“[Ni] at 300 days” in Table 2 below refers to the content of nickel in the produced oil (a fraction having a boiling point of 360° C. or higher) when 300 days have elapsed from the start of hydroprocessing.

The “number of days until 388° C.” in Table 2 below is the time required until the average of the temperatures (CAT) of all reactors (all catalyst layers) reaches 388° C. The longer the “number of days until 388° C.” is, the more the deactivation of each hydrogenation catalyst is suppressed, and the better activity of each hydrogenation catalyst to remove impurities in the heavy oil is maintained.

“[V] at 388° C.” in Table 2 below refers to the content of vanadium in the produced oil (a fraction having a boiling point of 360° C. or higher) when the average of the temperatures (CAT) of all reactors (all catalyst layers) reaches 388° C.

“[Ni] at 388° C.” in Table 2 below refers to the content of nickel in the produced oil (a fraction having a boiling point of 360° C. or higher) when the average of the temperatures (CAT) of all reactors (all catalyst layers) reaches 388° C.

### Comparative Examples 1 to 3

In Comparative Example 1, a conventional middle catalyst was used in place of the second hydrogenation catalyst.

In Comparative Example 2, neither the second hydrogenation catalyst nor the conventional middle catalyst was used.

In Comparative Example 3, the first hydrogenation catalyst was not used.

The proportion of the volume of each hydrogenation catalyst layer used in each of Comparative Examples 1 to 3 is shown in Table 2 below.

Hydroprocessing of each of Comparative Examples 1 to 3 was performed in the same manner as in Example 1 except for the matters described above. In the hydroprocessing of each of Comparative Examples 1 to 3, the same measurement as in Example 1 was performed. The measurement results of each of Comparative Examples 1 to 3 are shown in Table 2 below.

TABLE 2

| | | | Comparative | Comparative | Comparative |
|---|---|---|---|---|---|
| | Unit | Example 1 | Example 1 | Example 2 | Example 3 |
| First hydrogenation catalyst | vol % | 20 | 20 | 60 | 0 |
| V1/(V1 + V2 + V3) | | | | | |
| Second hydrogenation catalyst | vol % | 40 | 0 | 0 | 60 |
| V2/(V1 + V2 + V3) | | | | | |
| Conventional middle catalyst | vol % | 0 | 40 | 0 | 0 |
| V2/(V1 + V2 + V3) | | | | | |
| Third hydrogenation catalyst | vol % | 40 | 40 | 40 | 40 |
| V3/(V1 + V2 + V3) | | | | | |
| Reaction temperature at 300 days | ° C. | 388 | 393 | 397 | 390 |
| [V] at 300 days | mass ppm | 3.6 | 4.0 | 3.1 | 4.0 |
| [Ni] at 300 days | mass ppm | 3.2 | 3.5 | 2.8 | 3.5 |
| Number of days until 388° C. | days | 300 | 261 | 162 | 280 |
| [V] at 388° C. | mass ppm | 3.6 | 3.5 | 2.9 | 3.8 |
| [Ni] at 388° C. | mass ppm. | 3.2 | 3.1 | 2.8 | 3.4 |

The second hydrogenation catalyst in Example 1 was superior to the conventional middle catalyst in Comparative Example 1 in the performance of removing a poorly reactive metal component, so that the metal component was sufficiently removed in the second hydrogenation catalyst, and metal leakage to the third hydrogenation catalyst in Example 1 was suppressed. As a result, poisoning and deactivation of the third hydrogenation catalyst by the metal component were suppressed, and “the number of days until 388° C.” in Example 1 was extended by 39 days as compared with Comparative Example 1.

In Comparative Example 2 in which the second hydrogenation catalyst was not used, only the first hydrogenation catalyst specialized in the demetallization function was placed in the front of the third hydrogenation catalyst. As a result, a sufficient demetallization reaction did not proceed in the front of the third hydrogenation catalyst in Comparative Example 2, and “the number of days until 388° C.” in Comparative Example 2 was shorter by 138 days than in Example 1.

In Comparative Example 3 in which the first hydrogenation catalyst was not used, only the second hydrogenation catalyst specialized in the property to remove a poorly reactive metal component was placed in the front of the third hydrogenation catalyst. As a result, a sufficient demetallization reaction did not proceed in the front of the third hydrogenation catalyst in Comparative Example 3, and “the number of days until 388° C.” in Comparative Example 3 was shorter by 20 days than in Example 1.

### Examples 2 to 5 and Comparative Example 4

In the hydroprocessing in each of Examples 2 to 5 and Comparative Example 4, the mixed oil B was used as the heavy oil in place of the mixed oil A.

In Comparative Example 4, a conventional middle catalyst was used in place of the second hydrogenation catalyst.

The proportion of the volume of each hydrogenation catalyst used in each of Examples 2 to 5 and Comparative Example 4 is shown in Table 3 below.

Hydroprocessing of each of Examples 2 to 5 and Comparative Example 4 was performed in the same manner as in Example 1 except for the matters described above. In the hydroprocessing of each of Examples 2 to 5 and Comparative Example 4, the same measurement as in Example 1 was performed. The measurement results of each of Examples 2 to 5 and Comparative Example 4 are shown in Table 3 below.

TABLE 3

| | | | | | | Comparative |
|---|---|---|---|---|---|---|
| | Unit | Example 2 | Example 3 | Example 4 | Example 5 | Example 4 |
| First hydrogenation catalyst | vol % | 5 | 10 | 20 | 30 | 20 |
| V1/(V1 + V2 + V3) | | | | | | |
| Second hydrogenation catalyst | vol % | 40 | 40 | 40 | 40 | 0 |
| V2/(V1 + V2 + V3) | | | | | | |
| Conventional middle catalyst | vol % | 0 | 0 | 0 | 0 | 40 |
| V2/(V1 + V2 + V3) | | | | | | |
| Third hydrogenation catalyst | vol % | 55 | 50 | 40 | 30 | 40 |
| V3/(V1 + V2 + V3) | | | | | | |
| Reaction temperature at 300 days | ° C. | 386 | 385 | 382 | 384 | 387 |
| [V] at 300 days | mass ppm | 7.5 | 7.0 | 6.7 | 5.2 | 6.8 |
| [Ni] at 300 days | mass ppm | 5.4 | 5.0 | 4.8 | 4.4 | 4.9 |

In all of Examples 2 to 5, the “reaction temperature at 300 days” was lower than in Comparative Example 1. That is, Examples 2 to 5 showed that the use of the second hydrogenation catalyst extends the life of each hydrogenation catalyst regardless of the change in the proportion of the volume of each of the first hydrogenation catalyst and the third hydrogenation catalyst.

### Examples 6 and 7

In the hydroprocessing in each of Examples 6 and 7, the mixed oil B was used as the heavy oil in place of the mixed oil A.

The proportion of the volume of each hydrogenation catalyst used in each of Examples 6 and 7 is shown in Table 4 below.

Hydroprocessing of each of Examples 6 and 7 was performed in the same manner as in Example 1 except for the matters described above. In the hydroprocessing of each of Examples 6 and 7, the same measurement as in Example 1 was performed. The measurement results of each of Examples 6 and 7 are shown in Table 4 below. In Table 4 below, Examples 4, 6, and 7 and Comparative Example 4 in which the proportion of the volume of the third hydrogenation catalyst is the same are compared.

TABLE 4

| | | | | | Comparative |
|---|---|---|---|---|---|
| | Unit | Example 4 | Example 6 | Example 7 | Example 4 |
| First hydrogenation catalyst | vol % | 20 | 10 | 30 | 20 |
| V1/(V1 + V2 + V3) | | | | | |
| Second hydrogenation catalyst | vol % | 40 | 50 | 30 | 0 |
| V2/(V1 + V2 + V3) | | | | | |
| Conventional middle catalyst | vol % | 0 | 0 | 0 | 40 |
| V2/(V1 + V2 + V3) | | | | | |
| Third hydrogenation catalyst | vol % | 40 | 40 | 40 | 40 |
| V3/(V1 + V2 + V3) | | | | | |
| Reaction temperature at 300 days | ° C. | 382 | 382 | 384 | 387 |
| [V] at 300 days | mass ppm | 6.7 | 6.6 | 6.5 | 6.8 |
| [Ni] at 300 days | mass ppm | 4.8 | 4.8 | 4.7 | 4.9 |

In all of Examples 4, 6 and 7, the “reaction temperature at 300 days” was lower than in Comparative Example 4. That is, Examples 4, 6, and 7 showed that even when the total proportion of the volumes of the first hydrogenation catalyst and the second hydrogenation catalyst is fixed and the ratio of the volume of the second hydrogenation catalyst to the volume of the third hydrogenation catalyst varies, the life of each hydrogenation catalyst is extended by using the second hydrogenation catalyst.

### INDUSTRIAL APPLICABILITY

For example, the produced oil obtained by a heavy oil hydroprocessing method according to one aspect of the present invention may be used directly, or after secondary refining such as catalytic cracking, hydrocracking, or hydroprocessing, as a base material for heavy fuel oil, kerosene, light oil, gasoline, naphtha.

### REFERENCE SIGNS LIST

PD1_{MACRO} Median pore diameter of macropores in first hydrogenation catalyst
PD1_{MESO} Median pore diameter of mesopores in first hydrogenation catalyst
PD2_{MACRO} Median pore diameter of macropores in second hydrogenation catalyst
PD2_{MESO} Median pore diameter of mesopores in second hydrogenation catalyst

1. A heavy oil hydroprocessing method, comprising sequentially bringing a heavy oil into contact with a first hydrogenation catalyst, a second hydrogenation catalyst, and a third hydrogenation catalyst in the presence of hydrogen, wherein
the first hydrogenation catalyst, the second hydrogenation catalyst, and the third hydrogenation catalyst are placed in a downflow-type fixed bed reaction apparatus,
the first hydrogenation catalyst, the second hydrogenation catalyst, and the third hydrogenation catalyst are different catalysts,
both the first hydrogenation catalyst and the second hydrogenation catalyst include macropores and mesopores,
a pore diameter of the macropores is 50 nm or more,
a pore diameter of the mesopores is less than 50 nm,
a pore distribution of the first hydrogenation catalyst has a peak where a pore volume at a pore diameter of 50 nm or more reaches a local maximum and a peak where a pore volume at a pore diameter of less than 50 nm reaches a local maximum,
a pore distribution of the second hydrogenation catalyst has a peak where a pore volume at a pore diameter of 50 nm or more reaches a local maximum and a peak where a pore volume at a pore diameter of less than 50 nm reaches a local maximum,
a volume V1_{MACRO} of the macropores in the first hydrogenation catalyst is larger than a volume V2_{MACRO} of the macropores in the second hydrogenation catalyst,
a specific surface area of the first hydrogenation catalyst is 185 m²/g or more,
a specific surface area of the second hydrogenation catalyst is 160 m²/g or more, and
a content of a Group 6 element in the second hydrogenation catalyst is 5 mass % or more and 7 mass % or less.

2. A heavy oil hydroprocessing method, comprising sequentially bringing a heavy oil into contact with a first hydrogenation catalyst, a second hydrogenation catalyst, and a third hydrogenation catalyst in the presence of hydrogen, wherein
the first hydrogenation catalyst, the second hydrogenation catalyst, and the third hydrogenation catalyst are placed in a downflow-type fixed bed reaction apparatus,
the first hydrogenation catalyst, the second hydrogenation catalyst, and the third hydrogenation catalyst are different catalysts,
both the first hydrogenation catalyst and the second hydrogenation catalyst include macropores and mesopores,
a pore diameter of the macropores is 50 nm or more,
a pore diameter of the mesopores is less than 50 nm,
a pore distribution of the first hydrogenation catalyst has a peak where a pore volume at a pore diameter of 50 nm or more reaches a local maximum and a peak where a pore volume at a pore diameter of less than 50 nm reaches a local maximum,
a pore distribution of the second hydrogenation catalyst has a peak where a pore volume at a pore diameter of 50 nm or more reaches a local maximum and a peak where a pore volume at a pore diameter of less than 50 nm reaches a local maximum,
a median pore diameter PD1_{MACRO} of the macropores in the first hydrogenation catalyst is a pore diameter at which a cumulative volume of the macropores in the pore distribution of the first hydrogenation catalyst reaches 50% of the total volume of the macropores,
a median pore diameter PD2_{MACRO} of the macropores in the second hydrogenation catalyst is a pore diameter at which a cumulative volume of the macropores in the pore distribution of the second hydrogenation catalyst reaches 50% of the total volume of the macropores,
the median pore diameter PD1_{MACRO} is larger than the median pore diameter PD2_{MACRO},
a specific surface area of the first hydrogenation catalyst is 185 m²/g or more,
a specific surface area of the second hydrogenation catalyst is 160 m²/g or more, and
a content of a Group 6 element in the second hydrogenation catalyst is 5 mass % or more and 7 mass % or less.

3. The heavy oil hydroprocessing method according to claim 2, wherein
a volume V1_{MACRO} of the macropores in the first hydrogenation catalyst is larger than a volume V2_{MACRO} of the macropores in the second hydrogenation catalyst.

4. The heavy oil hydroprocessing method according to claim 2, wherein
the median pore diameter PD1_{MACRO} is 300 nm or more and 1500 nm or less, and
the median pore diameter PD2_{MACRO} is 100 nm or more and 500 nm or less.

5. The heavy oil hydroprocessing method according to claim 1, wherein
the volume V1_{MACRO} is 0.20 ml/g or more and 0.50 ml/g or less, and
the volume V2_{MACRO} is 0.10 ml/g or more and 0.35 ml/g or less.

6. The heavy oil hydroprocessing method according to claim 1, wherein
a volume V2_{MESO} of the mesopores in the second hydrogenation catalyst is 0.50 ml/g or more and 0.90 ml/g or less,
a median pore diameter PD2_{MESO} of the mesopores in the second hydrogenation catalyst is a pore diameter at which a cumulative volume of the mesopores in the pore distribution of the second hydrogenation catalyst reaches 50% of the total volume of the mesopores, and
the median pore diameter PD2_{MESO} is 6 nm or more and 20 nm or less.

7. The heavy oil hydroprocessing method according to claim 1, wherein
a distribution of the macropores among the pore distribution of each of the first hydrogenation catalyst and the second hydrogenation catalyst is measured by a mercury porosimetry, and
a distribution of the mesopores among the pore distribution of each of the first hydrogenation catalyst and the second hydrogenation catalyst is measured by a nitrogen adsorption method.

8. The heavy oil hydroprocessing method according to claim 1, wherein
a content of Group 8 to 10 elements in the second hydrogenation catalyst is 1.0 mass % or more and 3.0 mass % or less, and
a content of phosphorus in the second hydrogenation catalyst is 0.1 mass % or more and 2.0 mass % or less.

9. The heavy oil hydroprocessing method according to claim 1, wherein
contents of the Group 6 element and the Group 8 to 10 elements in the second hydrogenation catalyst are larger than contents of the Group 6 element and the Group 8 to 10 elements in the first hydrogenation catalyst, and
a unit of the contents is mass %.

10. The heavy oil hydroprocessing method according to claim 1, wherein
a volume of the first hydrogenation catalyst is represented by Vc1,
a volume of the second hydrogenation catalyst is represented by Vc2, and
a volume of the third hydrogenation catalyst is represented by Vc3, and
(Vc1+Vc2)/(Vc1+Vc2+Vc3) is 40 vol % or more and 70 vol % or less, and
(Vc2+Vc3)/(Vc1+Vc2+Vc3) is 60 vol % or more and 95 vol % or less.

11. The heavy oil hydroprocessing method according to claim 3, wherein
the median pore diameter PD1_{MACRO} is 300 nm or more and 1500 nm or less, and
the median pore diameter PD2_{MACRO} is 100 nm or more and 500 nm or less.

12. The heavy oil hydroprocessing method according to claim 3, wherein
the volume V1_{MACRO} is 0.20 ml/g or more and 0.50 ml/g or less, and
the volume V2_{MACRO} is 0.10 ml/g or more and 0.35 ml/g or less.

13. The heavy oil hydroprocessing method according to claim 2, wherein
a volume V2_{MESO} of the mesopores in the second hydrogenation catalyst is 0.50 ml/g or more and 0.90 ml/g or less,
a median pore diameter PD2_{MESO} of the mesopores in the second hydrogenation catalyst is a pore diameter at which a cumulative volume of the mesopores in the pore distribution of the second hydrogenation catalyst reaches 50% of the total volume of the mesopores, and
the median pore diameter PD2_{MESO} is 6 nm or more and 20 nm or less.

14. The heavy oil hydroprocessing method according to claim 2, wherein
a distribution of the macropores among the pore distribution of each of the first hydrogenation catalyst and the second hydrogenation catalyst is measured by a mercury porosimetry, and
a distribution of the mesopores among the pore distribution of each of the first hydrogenation catalyst and the second hydrogenation catalyst is measured by a nitrogen adsorption method.

15. The heavy oil hydroprocessing method according to claim 2, wherein
a content of Group 8 to 10 elements in the second hydrogenation catalyst is 1.0 mass % or more and 3.0 mass % or less, and
a content of phosphorus in the second hydrogenation catalyst is 0.1 mass % or more and 2.0 mass % or less.

16. The heavy oil hydroprocessing method according to claim 2, wherein
contents of the Group 6 element and the Group 8 to 10 elements in the second hydrogenation catalyst are larger than contents of the Group 6 element and the Group 8 to 10 elements in the first hydrogenation catalyst, and
a unit of the contents is mass %.

17. The heavy oil hydroprocessing method according to claim 2, wherein
a volume of the first hydrogenation catalyst is represented by Vc1,
a volume of the second hydrogenation catalyst is represented by Vc2, and
a volume of the third hydrogenation catalyst is represented by Vc3, and
(Vc1+Vc2)/(Vc1+Vc2+Vc3) is 40 vol % or more and 70 vol % or less, and
(Vc2+Vc3)/(Vc1+Vc2+Vc3) is 60 vol % or more and 95 vol % or less.
